(19) United States
(12) Patent Application Publication
(10) Pub. No.: US 2021/0324899 A1
(43) Pub. Date: Oct. 21, 2021

(54) SELF-ACTUATING FASTENER ASSEMBLIES

(71) Applicant: Albert Aguilar, Zapopan (MX)

(72) Inventor: Albert Aguilar, Zapopan (MX)

(21) Appl. No.: 17/116,575

(22) Filed: Dec. 9, 2020

Related U.S. Application Data
(60) Provisional application No. 62/945,700, filed on Dec. 9, 2019.
(60) Provisional application No. 62/945,708, filed on Dec. 9, 2019.

(51) Int. Cl. F16B 39/30; F16B 37/12; F16B 39/04

(52) U.S. Cl. CPC F16B 39/30; F16B 39/04; F16B 37/125

(57) ABSTRACT

The present invention provides a self-locking fastener assembly moveable from a stowed condition to a deployed condition. The assembly has a threaded insert, a nut, and a shear pin. The threaded insert has opposed ends, a first set of external threads, and a first radially extending through hole. The nut has an upper surface and an outer wall defining a central lumen. A second set of threads are disposed on an inner surface of the nut and engage the first set of threads. The nut has a second radially extending through hole. The shear pin is disposed in the second radially extending through hole when the assembly is in the stowed condition, and the shear pin extends through both the first radially extending through hole and the second radially extending through hole when the assembly is in the deployed condition, the shear pin being moveable from the stowed condition to the deployed condition upon rotation of the nut.

### CROSS-REFERENCE TO RELATED APPLICATIONS

This application claims the benefit of U.S. provisional patent application Ser. Nos. 62/945,700 and 62/945,708 both filed on Dec. 9, 2019, and are both incorporated herein by reference in their entirety and made a part hereof.

### FEDERALLY SPONSORED RESEARCH OR DEVELOPMENT

Not Applicable.

### BACKGROUND OF THE INVENTION

### 1. Technical Field

The present invention pertains to self-actuating fastener assemblies especially suitable for high vibration environments.

### 2. Background

Bolt assemblies having a bolt, a nut, and a locking nut or washer are well known for uses in manufacturing for high vibration conditions. It is imperative a bolt assembly is installed and placed in position on a machine or device that the nut not come loose inadvertently due to vibration of the machine or device. In commonly assigned U.S. Pat. No. 10,260,551 discloses a self-actuating lock nut and assemblies having a hex nut, a cylindrical sleeve, and a snap ring. The hex nut has a generally hexagonal shaped wall having a top surface, a bottom surface, a height dimension, and a central opening into a first central lumen. The first central lumen has a first inner surface supporting a first set of threads and a non-threaded annular slot proximate the central opening and axially spaced from the first set of threads. The annular slot has a greater diameter than the first set of threads. The cylindrical sleeve is coaxially disposed in the first central lumen and is moveable from a stowed position to a deployed position.

The sleeve has a first end portion extending axially beyond the bottom surface when in the stowed position and an opposed second end portion extending axially beyond the top surface when in the deployed position. The second end has a pair of axially spaced and radially extending flanges defining an annular groove therebetween to retain the snap ring. The cylindrical sleeve has an exterior surface supporting a second set of threads and a third set of threads on an inner surface. The second set of threads engage the first set of threads and require a first amount of torque applied about an axis of the first set of threads to cause relative rotation of the hex nut and the sleeve to move the sleeve from the stowed position to the deployed position. The snap ring is disposed in the annular groove and when the cylindrical sleeve is in the deployed position, the snap ring is in contact with the top surface.

The third set of threads are for engaging a fourth set of threads on a separate body such as a threaded rod. The threaded insert extends from a surface. The hex nut and sleeve assembly is threaded on the rod by engagement of the third set of threads with the fourth set of threads by applying a first amount of torque to initiate co-rotation of the hex nut and the cylindrical sleeve about the fourth set of threads, until the first bottom end portion of the sleeve contacts the surface. The torque required to continue co-rotation increases due to the pressed fit surfaces on the sleeve and a surface on the hex nut each slowly prying loose under the still continuous torque to the point where the first set of threads begins to move with respect to the second set of threads when a second amount of torque is applied, greater than the first amount of torque, in a continuous fashion until the first bottom end portion of the sleeve contacts the surface, and then until the hex nut bottom contacts the surface. As the bottom surface of the hex nut contacts the surface the second end of the sleeve extends axially outward from the top surface of the hex nut to define the deployed position. When in the deployed position, the lock ring is in surface contact with the top surface of the hex nut, the snap ring locks and resists further rotation of the hex nut assembly with respect to the rod. This helps prevent the loosening of the hex nut assembly due to vibrations or other environmental causes.

### SUMMARY OF THE INVENTION

The present invention provides a self-locking fastener assembly moveable from a stowed condition to a deployed condition. The assembly has a threaded insert, a nut, and a shear pin. The threaded insert has opposed ends, a first set of external threads, and a first radially extending through hole. The nut has an upper surface and an outer wall defining a central lumen. A second set of threads are disposed on an inner surface of the nut and engage the first set of threads. The nut has a second radially extending through hole. The shear pin is disposed in the second radially extending through hole when the assembly is in the stowed condition, and the shear pin extends through both the first radially extending through hole and the second radially extending through hole when the assembly is in the deployed condition, the shear pin being moveable from the stowed condition to the deployed condition upon rotation of the nut.

These and other aspects and attributes of the present invention will be discussed with reference to the following drawings and accompanying specification.

### BRIEF DESCRIPTION OF THE DRAWINGS:

FIG . 1 is a perspective view of a self-locking hex head fastener assembly.

FIG. 2 is a perspective view of an alternate embodiments of the self-locking hex head fastener assembly of FIG. 1.

FIGS. 3A,B,C,D,E,F are perspective views of numerous embodiments of threaded insert that can be deformed by a mallet.

FIG. 4 is a perspective view of an alternative embodiment of a threaded insert with two threads different from those shown in FIGS. 3A-3F.

FIG. 5 is a perspective view of an alternative embodiment of a threaded insert for a nut assembly.

FIG. 6 is a perspective view of a snap ring.

FIG. 7 is a perspective view of a system of parts for assembly into a self-locking hex head fastener assembly.

FIG. 8 is a perspective view of a system of parts for assembly into an alternative embodiment of a self-locking hex head fastener assembly.

FIG. 9 is a perspective view of a system of parts for assembly into an alternative embodiment of a self-locking hex head fastener assembly.

FIG. 10 is a perspective view of a system of parts for assembly into an alternative embodiment of a self-locking hex head fastener assembly.

FIG. 11 is a perspective view of a system of parts for assembly into an alternative embodiment of a self-locking hex head fastener assembly.

FIG. 12 is a perspective view of a system of parts for assembly into an alternative embodiment of a self-locking hex head fastener assembly.

FIG. 13 is a perspective view of a system of parts for assembly into an alternative embodiment of a self-locking hex head fastener assembly.

FIGS. 14A,B respectively are a perspective view of a system of parts and an assembly of parts into an alternative embodiment of a self-locking hex head fastener assembly.

FIG. 15 is a perspective view of a system of parts for assembly into an alternative embodiment of a self-locking hex head fastener assembly.

FIGS. 16A,B,C,D show diagrammatically a series of steps in deforming a top of a hex head fastener assembly.

FIG. 17 is a perspective view of a hex head fastener assembly in a stowed condition.

FIG. 18 is a perspective view of a hex head fastener assembly in a deployed condition.

FIG. 19 is an exploded view of a lock pin assembly.

FIG. 20 is a perspective view of a system of parts for assembly into a socket head self-locking fastener assembly.

FIG. 21 is a perspective view of a socket head self-locking fastener assembly in a stowed condition and a deployed condition.

FIG. 22 is a perspective view of an alternative embodiment of a socket head self-locking fastener assembly in a stowed condition and a deployed condition.

FIG. 23 is a top plan view and a side elevation view of a tooth washer.

FIG. 24 is a perspective view of a self-locking nut assembly in a stowed condition.

FIG. 25 is a transparent view of the assembly of FIG. 24.

FIG. 26 is a perspective view of a self-locking nut assembly in a deployed condition.

### DETAILED DESCRIPTION

The present invention is susceptible to embodiments in many different forms. Preferred embodiments of the invention are disclosed with the understanding that the present disclosure is to be considered as exemplifications of the principles of the invention and are not intended to limit the broad aspects of the invention to the embodiments illustrated.

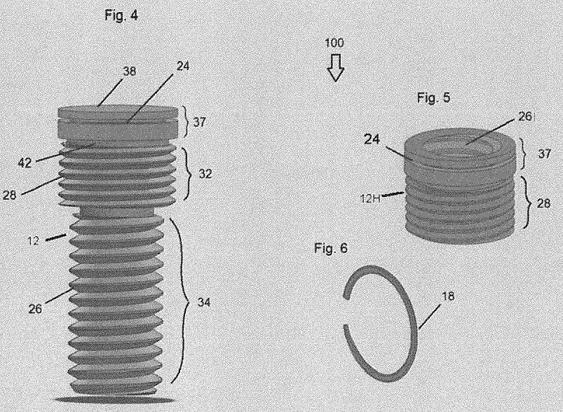

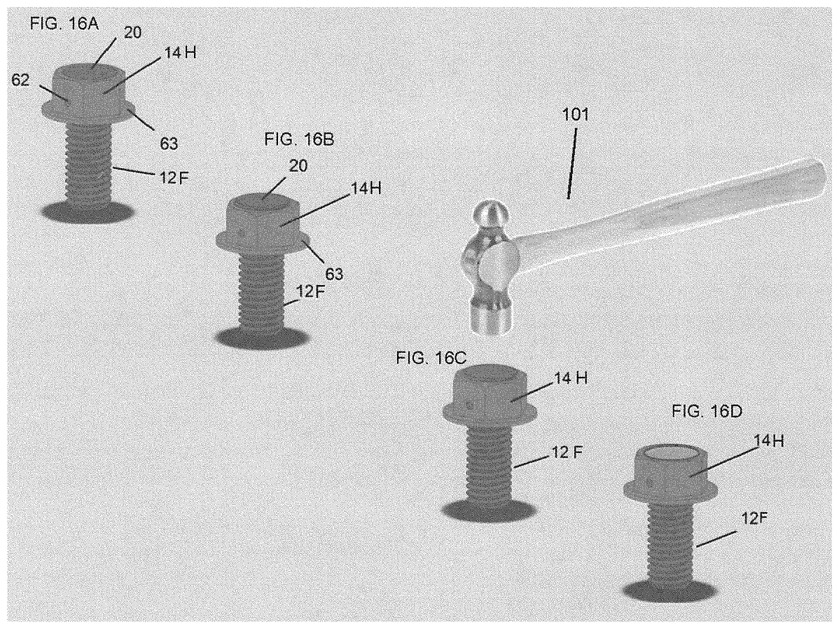

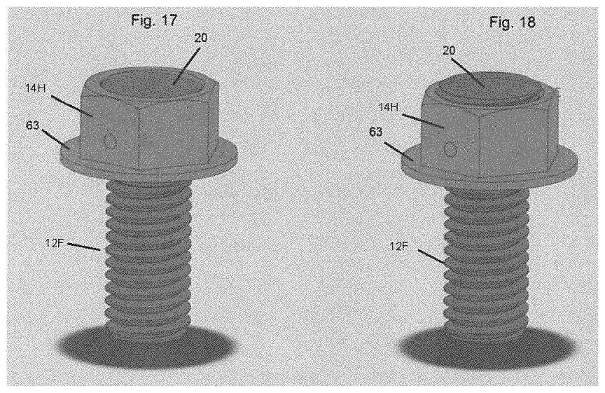

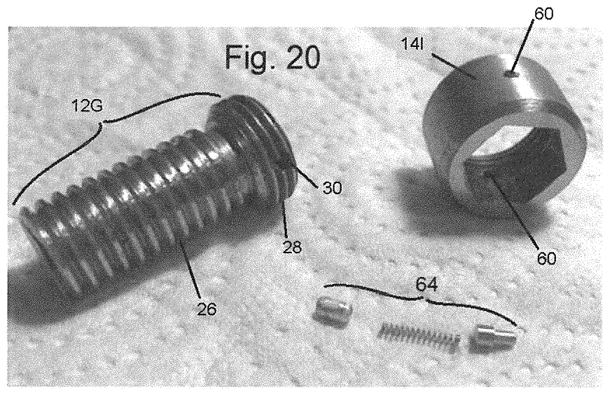

The present invention provides numerous embodiments of a self-locking fastener hex head fastener assemblies (FIGS. 1-15), hex head fastener assemblies that require deforming a top end of an insert to lock a hex head onto a threaded insert (FIGS. 16-18), and self-locking fastener socket head assemblies (FIGS. 20-23). Suitable self-socking fasteners should fulfill the following nine requirements:
1. Have few components (nuts, washers, spring washers, screws) at point of installation or application.
2. The fastener installation has to be a continuous one-step process.
3. The screw must be reusable (screw threads cannot be damaged or altered on first application)
4. There must be positive mechanical stops (fastener components cannot back up by vibration or elongation effects)
5. Maintain constant initial clamping torque (the screws and nuts have to maintain original clamping preload)
6. Automation friendly—it has to be a continuous motion without stops
7. Torque indication (screws and nuts have to be installed at known torque settings)
8. Meet industry standards (ASME, SAE, ASTM, DIN, and others known to those having ordinary skill in the art). Engineering societies have over the years made provisions for the capable uses of screws and nuts, such as sizes needed to use for standard tooling or share dimensions needed for holes and clearances so as to allow other designers to us these in their washers, lock nuts, bolt and screw designs.
9. Specialty—the fastener design must be novel and therefore protected to boost profits

FIG. 1 shows a self-locking fastener assembly 10 and system 100 having a threaded insert 12, a nut 14, a shear pin 16, and a snap ring 18. The threaded insert 12 has numerous embodiments 12, 12A,B,C,D,E,F,G,H as shown in FIGS. 1-26. The threaded insert 12 of FIGS. 1, 3B, and 4 is a dual threaded type and has a top end 20, a press fit portion 22, a groove 24 for receiving the snap ring 18, a first stage set of threads 26, a second stage set of threads 28, and a radially extending through hole 30. In this assembly, the threaded insert 12 is segmented into a first area 32 having a first diameter and a second area 34 having a second diameter less than the first diameter. The areas are disposed in tandem relationship as opposed to one on top of the other. An unthreaded area 36 is disposed between the first and second areas 32,34. A third area 37 of the threaded insert extends from the second area and forms a top end of the threaded insert. A top surface 38 of the threaded insert has a machined planar surface 38 to form a press fit mating surface. An outer peripheral edge of the third area has an annular slit 40 to define a snap ring nesting groove 40. The third area is separated from the first area by a second unthreaded area 42.

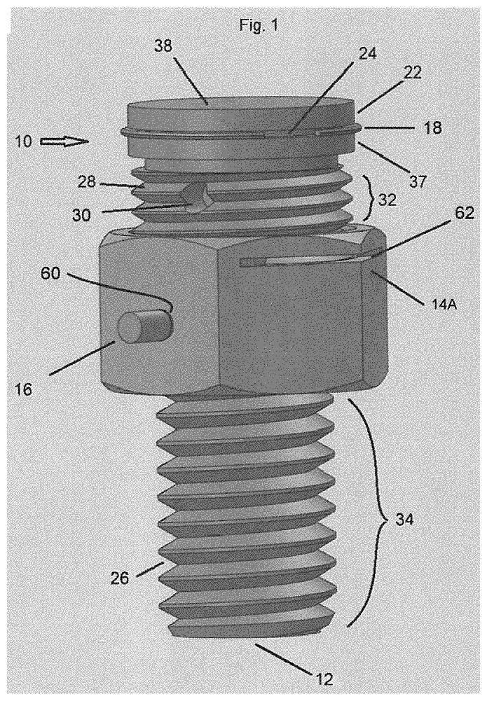

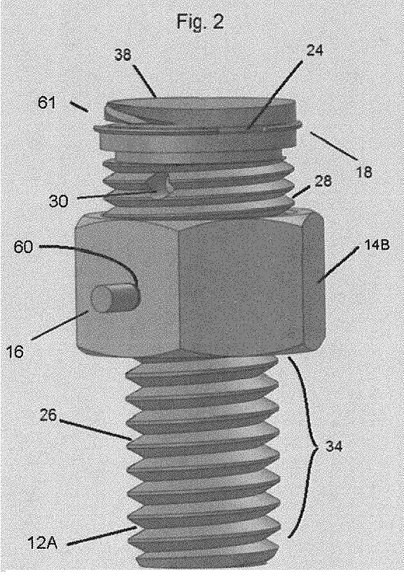

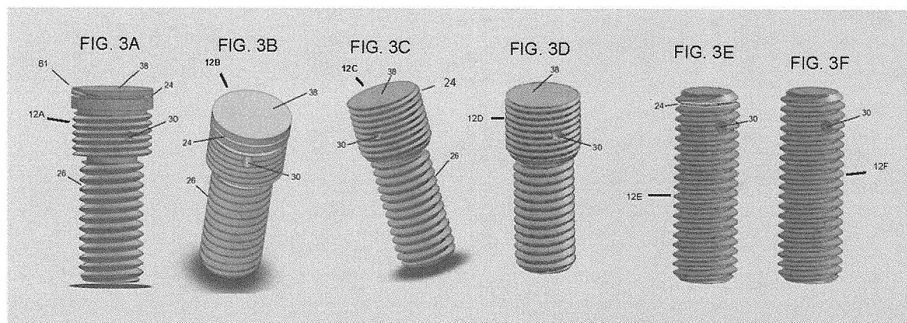

The threaded insert 12A of FIG. 2 differs from insert 12 by having a slit cut 61. Threaded insert 12C of FIG. 3C is the same as insert 12 but has no third area 37. Threaded insert 12D of FIG. 3D is the same as insert 12 but has no snap ring retaining groove 18. Threaded insert 12E of FIG. 3E has a single thread with a recess groove 24. Threaded insert 12F of FIG. 3F has a single thread and no groove 24. Threaded insert 12G of FIG. 20 is for use with a hex bolt 14G and has the first and second set of threads 26,28 with the through hole 30 in the second set of threads 28. Threaded insert 12H has an opening defining a lumen and has the first stage set of threads 26 on an interior surface, the second stage threads 28 on an external surface, the third area 37 on an external surface, and the snap ring nesting groove 24.

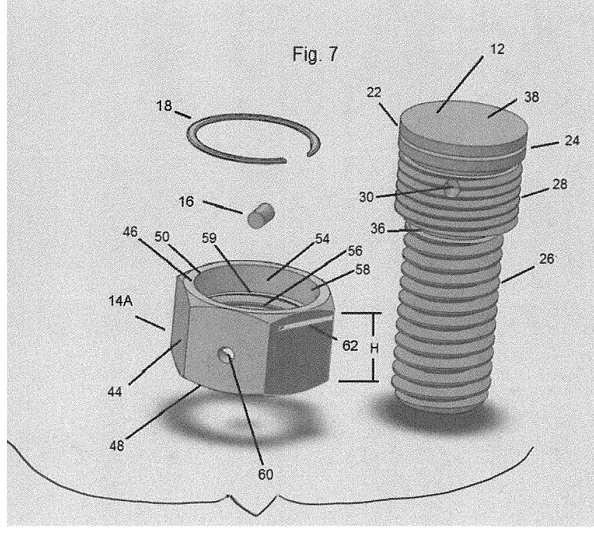

The nut 14A has a generally hexagonal shaped wall 44 having a top surface 46, a bottom surface 48, a height dimension H, and a central opening 50 into a first central lumen. The first central lumen has a first inner surface 54 supporting a third set of threads 56 and a non-threaded annular slot 58 (FIG. 7) or counterbore proximate the central opening and axially spaced from the third set of threads 58 by an annular shelf 59. The annular shelf 59 has a planar surface that engages the machined planar surface 38 when the assembly is in a deployed condition. slot 58 has a greater diameter than the third set of threads 56. A side slot 60 is cut through the wall 44 to accommodate installation of the snap ring 18. A through hole 62 is provided to accommodate the shear pin 16.

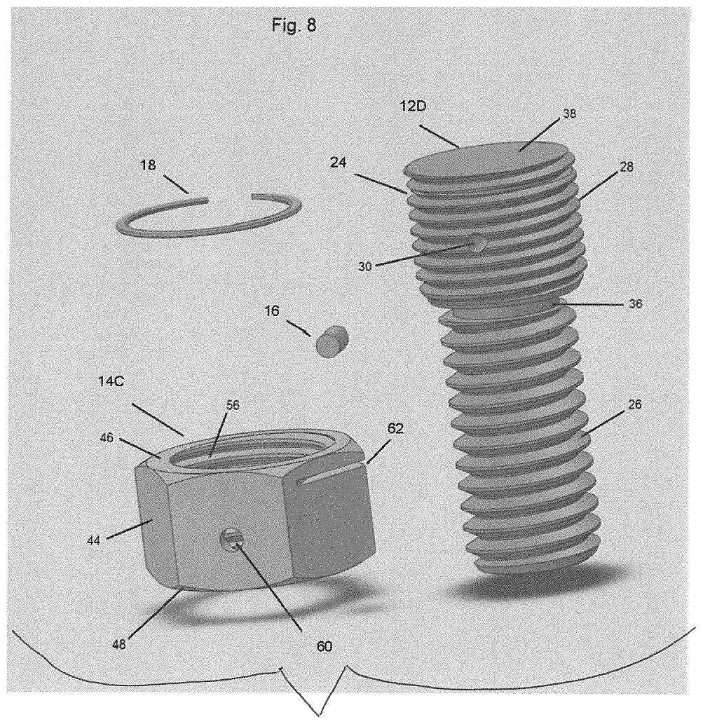

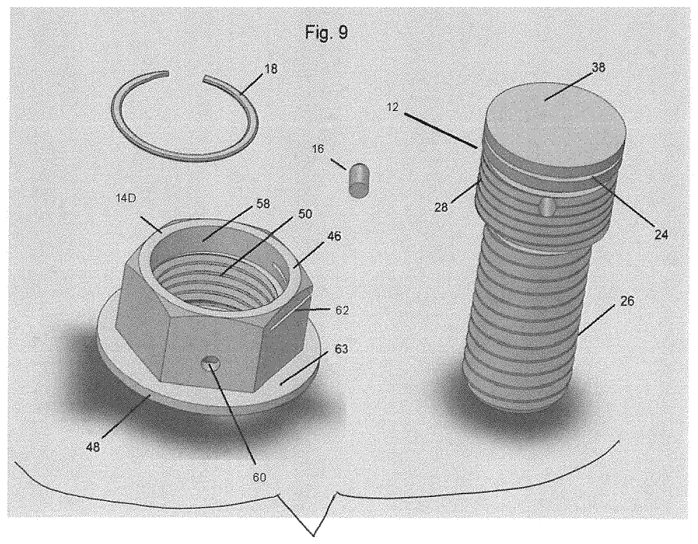

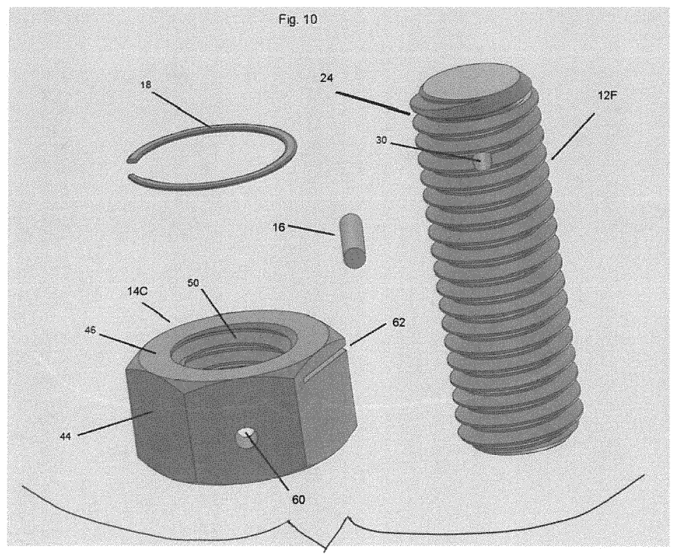

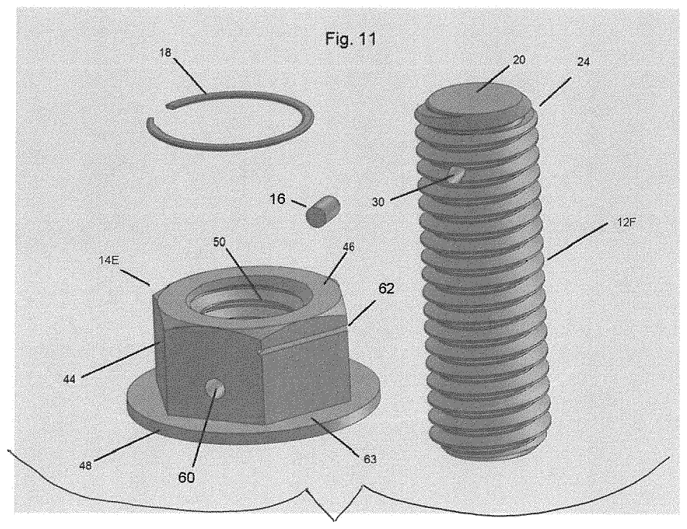

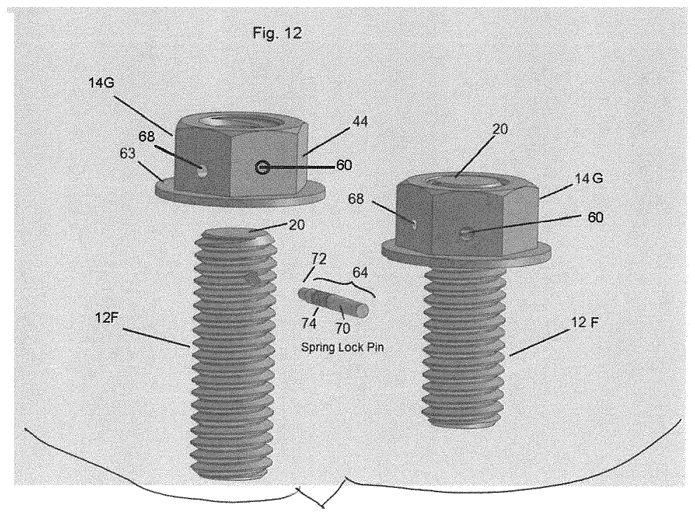

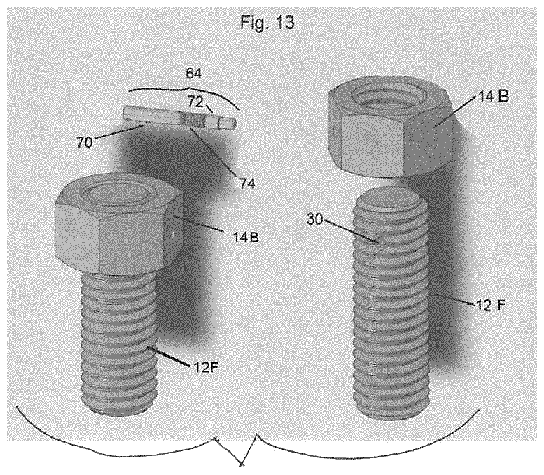

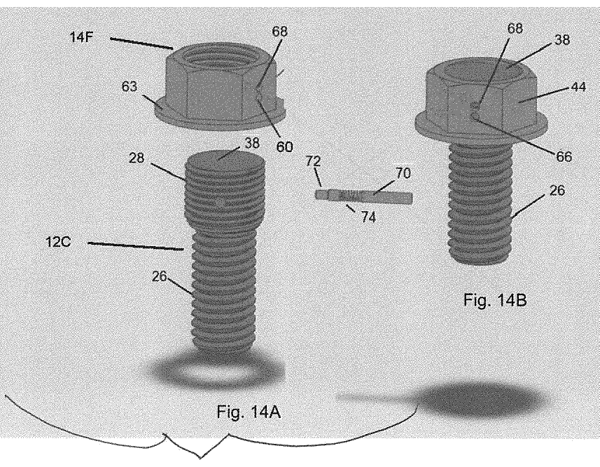

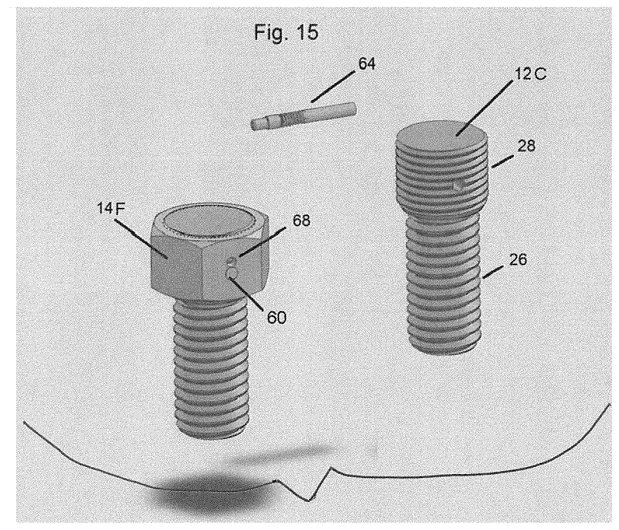

The nut 14A has alternate embodiments 14B,C,D,E,F,G,H,I as shown in the figures. Nut 14B of FIGS. 2 and 13 is the same as that of 14A but does not have a slot 62. Nut 14C of FIGS. 8 and 10 is the same as 14A but does not have a counterbore 58, rather the internal threads extend to the top of the nut. Nut 14D of FIG. 9 is the same as 14A except that it has a bottom flange 48. Nut 14E is the same as nut 14C but has a bottom flange 48 as shown in FIG. 11. Nut 14F of FIGS. 14 and 15 is the same as nut 14E but lacks slot 62 and has two through holes 60,68 axially spaced from one another on the same face of the nut. Nut 14G of FIG. 12 is the same as nut 14F but has the two through holes 60,68 circumferentially spaced from one another and on adjacent faces of the nut. Nut 14H of FIGS. 16-18 is the same as nut 14B but has a bottom flange 63. Nut 14I of FIGS. 20-22 is a socket head nut having a hexagonal shaped inner wall and two through holes 60 circumferentially spaced from one another by 180°.

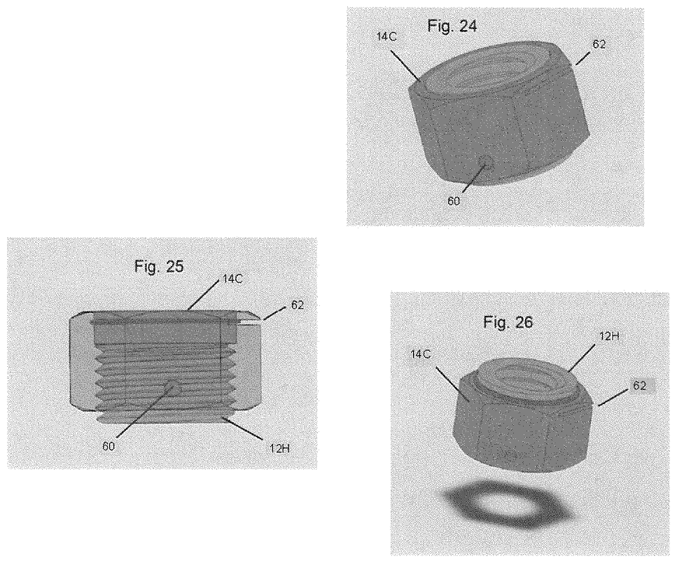

To prepare the fastener assembly 10 for use, the nut 14A is moved upward as shown in FIG. 1 until the through hole 60 of the nut is in alignment with the through hole 30 of the threaded insert. The shear pin 16 is inserted through both holes so that the nut and threaded insert are locked together to co-rotate during a first stage of threading. The fastener assembly will be described for engaging a surface having a threaded hole having a fourth set of threads that mate with the first stage set of threads 26. As is shown in FIG. 24, the top surface 22 of the insert is below or flush with the top surface 46 of the nut when in a stowed condition. The first stage set of threads 26 will be engaged to the fourth set of threads until the bottom surface 48 of the nut engages the surface. In a second stage of threading, a second amount of torque greater than the first amount is applied to exceed a shear limit of the shear pin and the shear pin breaks. Now the third set of threads 56 of the nut 14A engage the second stage set of threads 28 and the nut begins to move along the threaded insert until the top end 20 of the insert extends above the top surface 46 of the nut to allow the snap ring to engage the top end 20 of the insert as shown in FIG. 26 to define a deployed condition.

FIG. 2 shows a fastener assembly using a threaded insert 12A having a slit cut 61 at the top surface 38 of the insert 12A that provides a ramp or camming surface for ease of insertion of the snap ring 18 into the slit cut 61 and the side slot 62. FIG. 9 shows a fastener system that is the same as that shown in FIGS. 7 and 8 with the exception of the use of a nut 14D having a flange 63 which will be referred to as a flanged-nut. FIGS. 10 and 11 show fastener systems using a threaded insert 12F having a single thread.

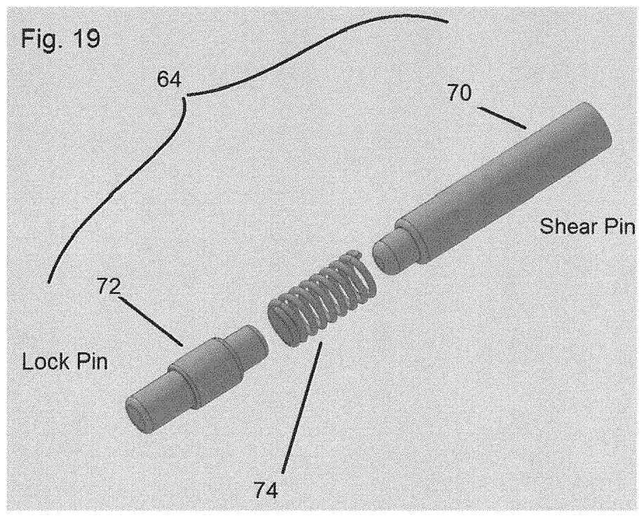

FIGS. 12-15 show fastener systems that utilize a spring lock pin 64 (FIG. 19) in place of the shear pin 16 and the snap ring 18. The spring lock pin 64 has a lock pin 70, a shear pin 72, and a spring 74. The first port hole 66 is brought into alignment with the through hole 30 of the threaded insert and the spring lock pin 64 is inserted through the aligned holes to lock together the nut and the threaded insert for co-rotation about the axis of the insert. As described above, upon rotation of the nut and insert using a first torque, the threaded insert can engage a threaded hole in a surface until a second amount of torque is reached causing the shear pin to break. The nut then begins to rotate with respect to the insert and the spring pushes the lock pin 70 against an inner surface of the nut until the lock pin reaches the second port hole 68 where the spring 74 pushes the lock pin 70 into the second port hole 68 where it resides to define the deployed condition. The first port and the second port 60,68 are circumferentially spaced from one another by a desired amount such as a fraction of a full rotation. The first port and the second port 60,68 can also be axially spaced from one another as shown in FIG. 15 to accommodate a full rotation or several full rotations. FIGS. 12-13 show the system with a single threaded insert 12F and FIGS. 14-15 show the system using a dual threaded insert 12C.

FIGS. 16-18 show alternative embodiments that do not utilize a snap ring. Instead the assembly has the nut 1411, shear pin 16, and the threaded insert 12F. As in the above embodiments, the nut and insert co-rotate upon the application of a first torque to the nut until a second torque is reached snapping the shear pin. The nut is rotated until the top of the insert extends above the top surface of the nut as shown in FIG. 18. A hammer 101 or pneumatic tool is used as shown in FIG. 16 to deform the top portion of the insert to damage the threads of the insert in this area to define a deployed condition.

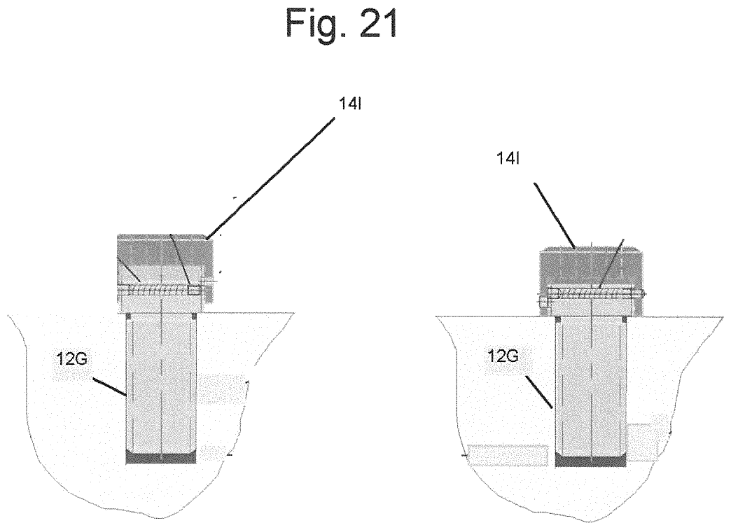

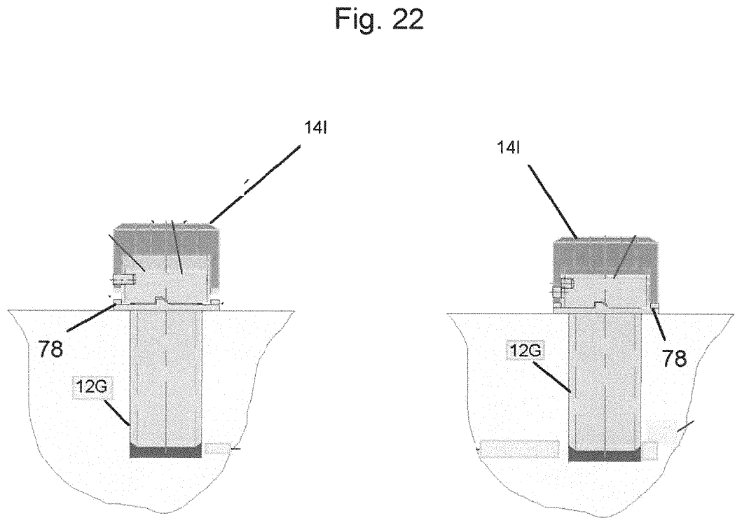

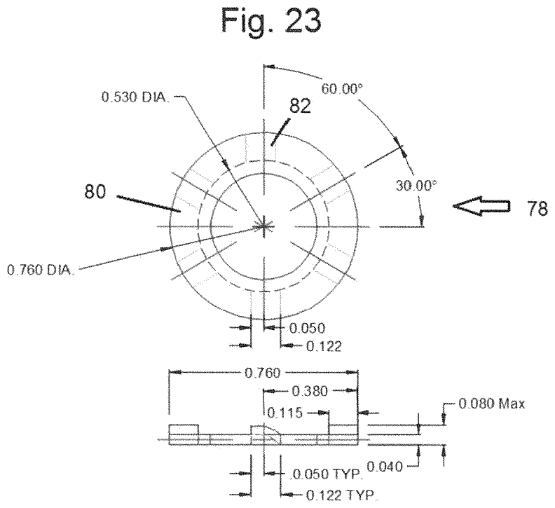

FIGS. 20-21 show a self-locking fastener assembly using a socket head nut, 14I the threaded insert 12G, and the spring lock pin 64. FIG. 21, left panel, shows the fastener assembly in the stowed position and FIG. 21, right panel, shows the assembly in a deployed condition. FIGS. 22-23 use the socket head nut 14 , shear pin 16, and a toothed washer 78. FIG. 22, left panel, shows the fastener assembly in a stowed position, and FIG. 22, right panel, shows the fastener in a deployed condition. FIG. 23 shows the toothed washer 78 having a generally flat ring 80 with upstanding flanges 82 circumferentially spaced.

FIGS. 24-26 show a self-locking bolt assembly having the nut 14C shear pin 16, and snap ring 18 as described above. The self-locking bolt assembly can be used with a threaded rod for self-locking thereto.

Any of the threads mentioned herein can be formed in accordance with industrial standards, for example, UNF (fine) threads and UNC (coarse) threads. The hex nut and screw of this invention coincides with standard ANSI hex screw and nut sizes to be used in conjunction with prior art tooling. The shear pins described herein are designed to break upon the application of a specific torque.

While specific embodiments have been illustrated and described, numerous modifications come to mind without departing from the spirit of the invention and the scope of protection is only limited by the scope of the accompanying claims.

I claim:

1. A self-locking fastener assembly moveable from a stowed condition to a deployed condition comprising:
a threaded insert having opposed ends, a first set of external threads, and a first radially extending through hole;
a nut having an upper surface and an outer wall defining a central lumen and a second set of threads disposed on an inner surface of the nut and engaging the first set of threads, the nut has a second radially extending through hole; and, a shear pin disposed in the second radially extending through hole when the assembly is
in the stowed condition, and the shear pin extends through both the first radially extending through hole and the second radially extending through hole when the assembly is in the deployed condition, the shear pin being moveable from the stowed condition to the deployed condition upon rotation of the nut.

2. The assembly of claim 1 further comprising:
a recess groove in an end of the threaded rod; and
a snap ring disposed in the recess groove.

3. The assembly of claim 2 wherein the snap ring extends above the upper surface when the assembly is in the deployed condition.

4. The assembly of claim 2 further comprising a slot through the outer wall of the nut to accommodate the passage of the split ring from beyond the outer wall to within the outer wall during an assembly process.

5. The assembly of claim 1 wherein the threaded insert has a second set of threads.

6. The assembly of claim 5 wherein the second set of threads is disposed in tandem relationship to the first set of threads.

7. The assembly of claim 6 wherein the first set of threads is a coarse set and the second set of threads is a fine set.

8. The assembly of claim 1 wherein the threaded insert has two segments, a first segment has a first outer diameter and the second segment has a second outer diameter less than the first outer diameter.

9. The assembly of claim 8 wherein the threaded insert has an unthreaded portion between the first segment and the second segment.

10. The assembly of claim 1 wherein the nut is a hex nut or a socket head nut.

11. The assembly of claim 1 wherein the shear pin further comprises a spring and a lock pin to define a spring lock pin.

12. The assembly of claim 11 wherein the nut has a third radially extending through hole circumferentially spaced from the second radially extending through hole.

13. The assembly of claim 11 wherein the nut has a third radially extending through hole axially spaced from the second radially extending through hole.

14. The assembly of claim 1 wherein the nut has a counterbore section having no threads and defines an annular shelf

15. The assembly of claim 14 wherein a top surface of the threaded insert has a planar surface that contacts the annular shelf when the assembly is in the deployed condition.

16. The assembly of claim 11 wherein the shear pin resides in the second radially extending through hole when the assembly is in the stowed condition and the lock pin resides in the third radially extending through hole when the assembly is in the deployed condition.

17. The assembly of claim 2 wherein the threaded insert has a slit cut into the recessed groove.

18. The assembly of claim 1 further comprising a toothed washer mounted on the threaded insert.
